(19) United States
(12) Patent Application Publication
(10) Pub. No.: US 2014/0171343 A1
(43) Pub. Date: Jun. 19, 2014

(54) BIOLOGICAL DETECTING CHIP

(71) Applicant: ARDIC INSTRUMENTS CO., Taipei City (TW)

(72) Inventors: YU CHENG SU, Dayuan Township (TW); CHIA-YING LEE, Taipei City (TW); CHIAO-TUNG CHANG, Douliu City (TW); CHENG HAN CHEN, New Taipei City (TW)

(73) Assignee: ARDIC INSTRUMENTS CO., Taipei City (TW)

(21) Appl. No.: 13/744,694

(22) Filed: Jan. 18, 2013

(30) Foreign Application Priority Data
Dec. 14, 2012 (TW) 101147458

(51) Int. Cl. G01N 21/15

(52) U.S. Cl. CPC G01N 21/15
USPC 506/39

(57) ABSTRACT

A biological detecting chip comprising an optical fiber, at least one gas filter, an upper cap and a substrate is disclosed. The optical fiber has at least one detecting area disposed on an outer surface. The upper cap has at least two guiding channels passed through the upper cap, at least one discharge channel with two ends connecting to an upper portion of distinct guiding channels, an inlet and an outlet, wherein the gas filter is attached to an upside of the discharge channel to separate the discharge channel and an outside of the upper cap. The substrate has a test area and a plurality of directing channels, wherein the directing channel connects to the inlet and the guiding channel, connects to the guiding channel and the test area, and connects to the test area and the outlet.

### BACKGROUND OF THE INVENTION

1. Field of the Invention

The present invention relates to a biological detecting chip, particularly to a biological detecting chip for detecting optical fiber with nanoparticles.

2. Description of Related Art

A lab-on-a-chip is an effective device that disposes a plurality of fluidic channels thereon and is able to integrate more than one experiment on such a single chip or to perform a high-throughput detection of biological sample. Interactions between biomolecules such as proteins, DNAs, or RNAs could be effectively analyzed inside small fluidic channels of the chip.

One existing new technology is named Fiber Optical Particle Plasmon Resonance (FOPPR). An optical-fiber is utilized in the apparatus for detecting biological organisms in nano-scale. When an optical signal passes through the optical fiber, the light will be absorbed via Surface Plasma Resonance (SPR) effect induced by gold nanoparticles which resulted from the interaction of biological molecules, so as to detect various biological characteristics of proteins or bio-organisms and to be the biologically experimental base of immunoassay. Practically, FOPPR can be applied to do quantitative or kinetic analyses of proteins DNAs, RNAs or other small particles. Notably, it takes only one kind of antibody each time for FOPPR to achieve a highly sensitive quantitative analysis of proteins. FOPPR system utilizes the concept of Lab-on-a-chip and has an optical fiber disposed inside a fluidic channel to conduct experiments of interaction between biomolecules; to elaborate, FORRP has gold nanoparticles coated on the sensing area of the optical fiber and has biological ligands immobilized thereon. When the analytes contact with the biological ligands immobilized on the gold nanoparticles, the interaction between the biological samples and the biological ligands can be analyzed due to the signal variation (i.e., the wavelength shifting or variation of optical intensity), and a qualitative analysis or quantitative analysis of the biological samples can be carried out.

Even though biosensors are promising to be used in various fields such as medical, pharmaceutical, environmental, defensive, bioprocessing, and food technological fields, the main obstacle for commercializing biosensors is bubbles stuck or accumulated in microfluidic channels. Surface roughness of the channel, the inappropriate microfluidic chamber design, and the turbulent flow that appears in the microfluidic channel all can lead to generation of bubbles. Moreover, in an optical detection system, undesired accumulation of bubbles in microfluidic channels can cause serious problems. The pressure and the flow rate in the microfluidic channel therefore change all the time and thus lead to system instability, which further devastates the ongoing analysis.

In order to solve this problem, Changchun Liu et. al. (“A membrane-based, high-efficiency, microfluidic debubbler”. Lab Chip, 2011, Vol.11, p1688-1693) disclose a PTFE film with hydrophobic and porous membrane. The membrane is incorporated into the fluidic channel with altitude differences so that bubbles may be efficiently removed from the fluidic channel by means of the PTFE film and the pressure drop. In addition, Harald van Lintel et. al. (“High-Throughput Micro-Debubblers for Bubble Removal with Sub-Microliter Dead Volume”, Micromachines, 2012, Vol.3 (2), p218-224) demonstrate a hydrophobic, permeable and water-resistant material. In this invention, bubbles are urged to pass through the hydrophobic material due to their greater buoyancy and then are removed from the fluidic channel. Yet, Jong Hwan Sung et. al. (“Prevention of air bubble formation in a microfluidic perfusion cell culture system using a microscale bubble trap”, Biomedical Microdevices. 2009, Vol.11, p731-738) further demonstrate confining bubbles in a hole by a bubble trap; in this manner, bubbles would not be able to flow along with the fluid any longer, and the fluid is thus degassed.

As mentioned, these well-known solutions are complicated and of low reproducibility. Intuitional observation, compact integration of chip, and de-bubbling, which can effectively enhance SPR phenomenon and still maintain sensitivity and accuracy of data, are substantially required in future developmental strategy.

### SUMMARY OF THE INVENTION

The primary object of the present invention is to resolve the problem of bubble accumulation in the fluidic channel of a biological detecting chip, so as to increase the SPR effect among the gold nanoparticles in the sensing area of the optical fiber and to accurately detect experimental data.

To achieve the above purposes, a biological detecting chip is disclosed. The biological detecting chip comprises an optical fiber, at least one gas filter, an upper cap and a substrate. The optical fiber has at least one detecting area disposed on an outer surface. The upper cap has at least two guiding channels passed through the upper cap, at least one discharge channel with two ends connecting to an upper portion of distinct guiding channels, a inlet and an outlet, wherein the gas filter is attached to an upside of the discharge channel to separate the discharge channel from an outside of the upper cap. The substrate has a test area and a plurality of directing channels, wherein the directing channel connects to the inlet and the guiding channel, connects to the guiding channel and the test area, and connects to the test area and the outlet. The optical fiber is fixed between the upper cap and the substrate, with the detecting area disposed inside the test area and having an optical axis which crosses the directing channel by an angle.

According to one embodiment of the biological detecting chip, wherein an upper surface of the upper cap has at least one receiving room disposed next to the discharge channel and selectively containing the gas filter.

According to one embodiment of the biological detecting chip, wherein the guiding channel is vertically disposed.

According to one embodiment of the biological detecting chip, wherein the directing channel is horizontally disposed.

According to one embodiment of the biological detecting chip, wherein the number of the gas filter and the discharge channel are pluralities, and each of the directing channels connects to distinct guiding channels.

According to one embodiment of the biological detecting chip, wherein the angle ranges from 1 to 90 degrees.

According to one embodiment of the biological detecting chip, wherein the substrate has at least one wall to isolate and encircle the directing channel. The wall either protrudes or has a higher altitude than an upper surface of the substrate.

According to one embodiment of the biological detecting chip, wherein the substrate has at least one wall to isolate and encircle the directing channel. An outside of the wall has a trough concaved and disposed next to the wall.

According to one embodiment of the biological detecting chip, wherein the substrate has a plurality of fitting elements fastened to the upper cap or passed through the upper cap.

The biological detecting chip according to the present invention may effectively control the generation of bubbles inside the channel of the chip. Therefore, the plasma effect of the gold nanoparticles on the optical fiber is increased, and the biochip is improved in its sensing accuracy of experimental signals. Thus the commercialization of the present invention is predictable.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 is an exploded-view diagram of the biological detecting chip of the present invention;

FIG. 2A-2C are schematic diagrams of the biological detecting chip after being assembled;

FIG. 3 is schematic diagrams of the working fluid flowing inside the biological detecting chip;

FIG. 4 is schematic diagrams showing the disposition of the wall and the trough of the biological detecting chip.

### DETAILED DESCRIPTION OF THE PREFERRED EMBODIMENTS

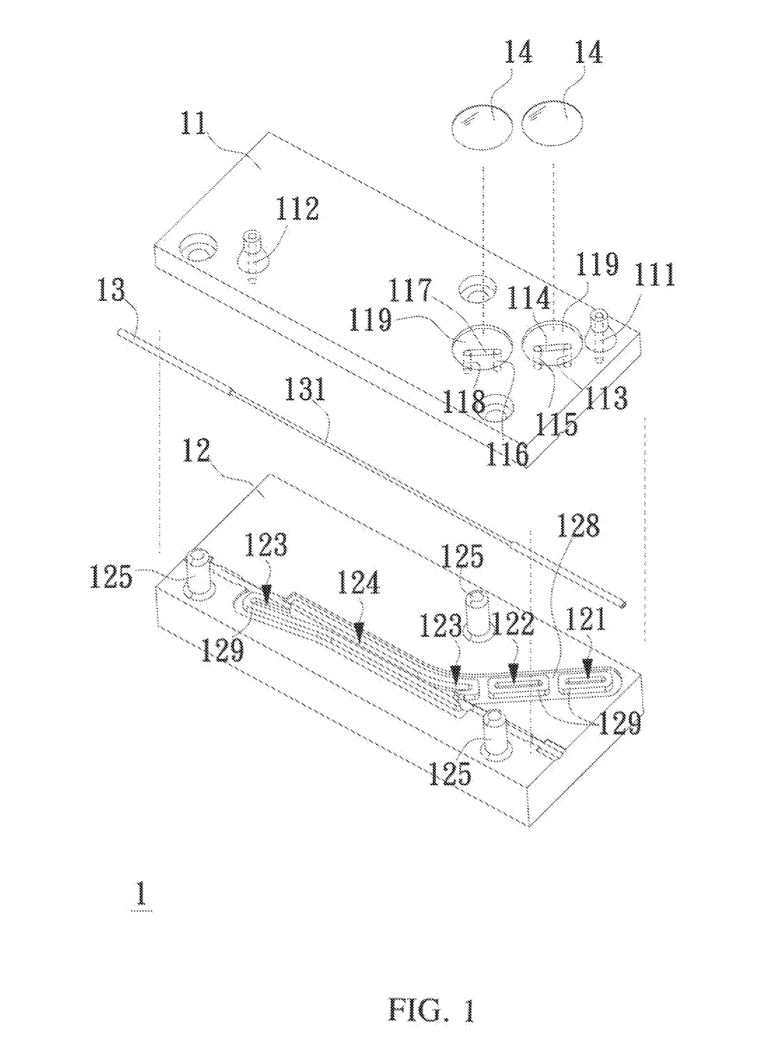

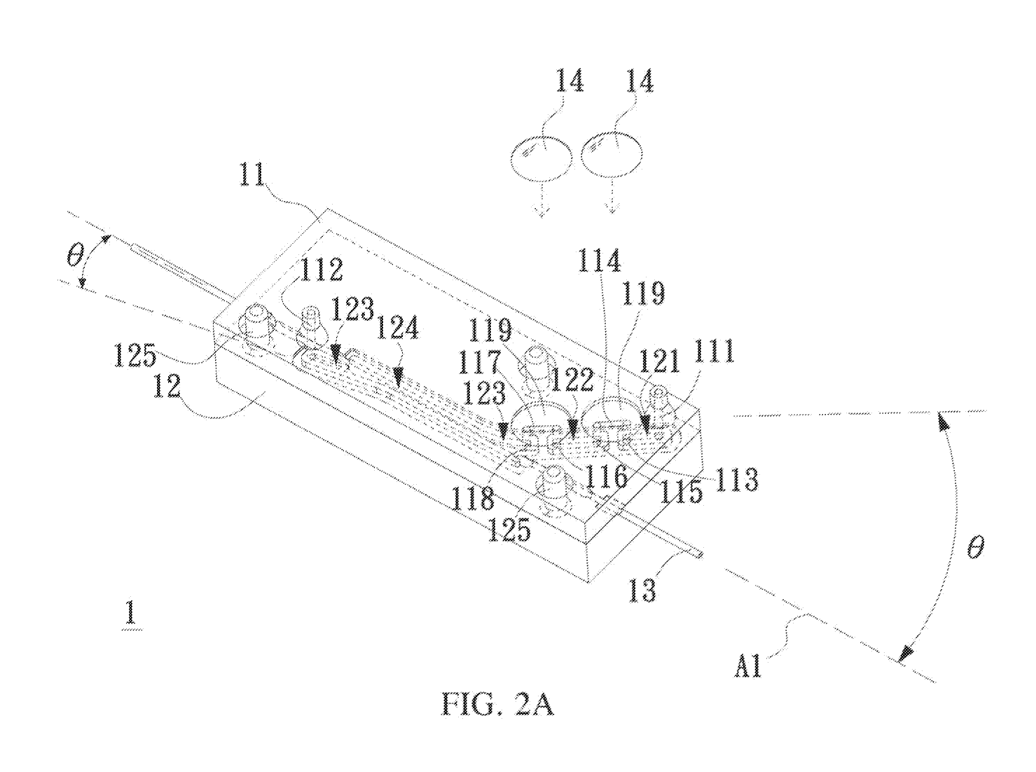

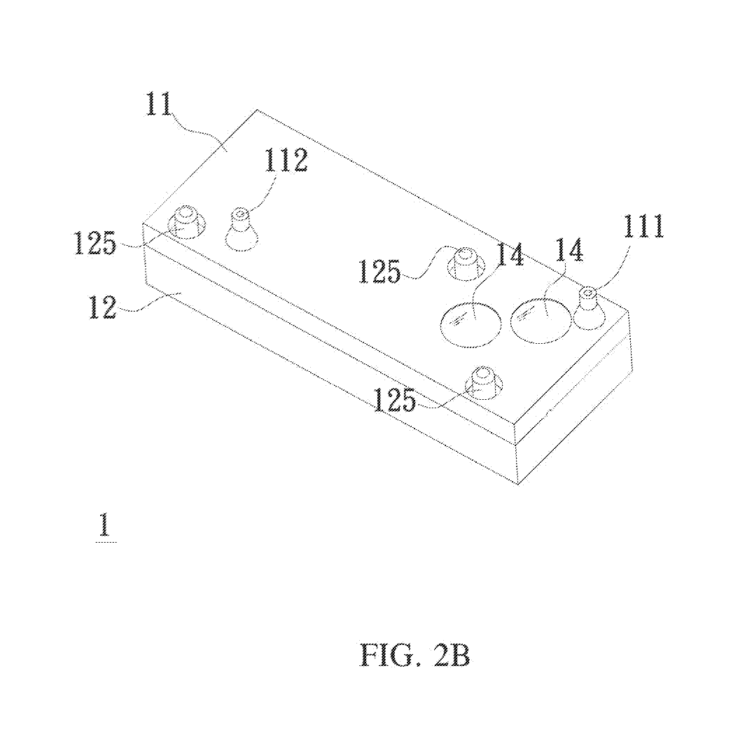

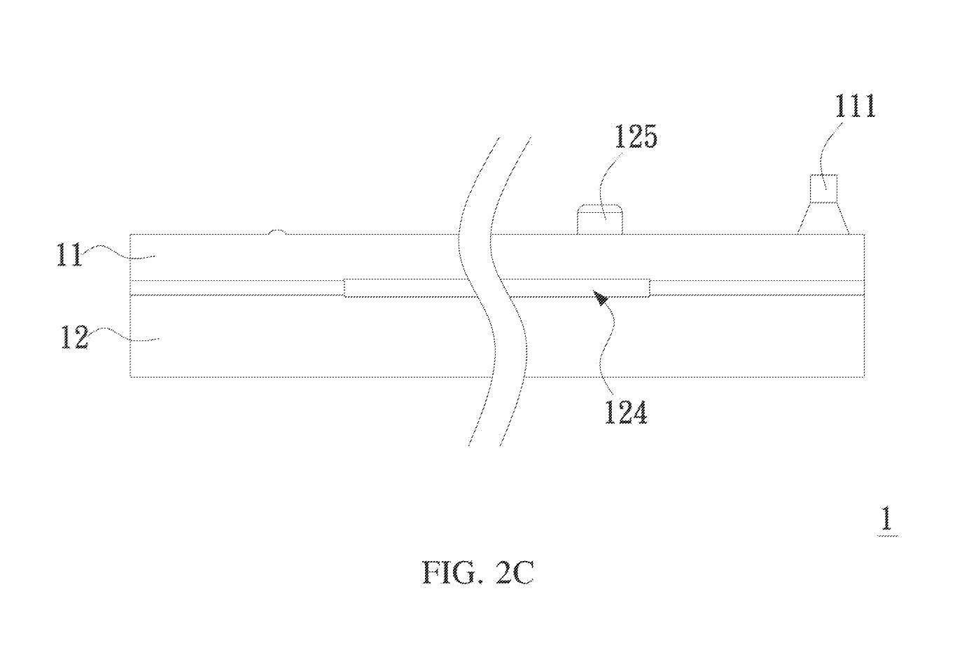

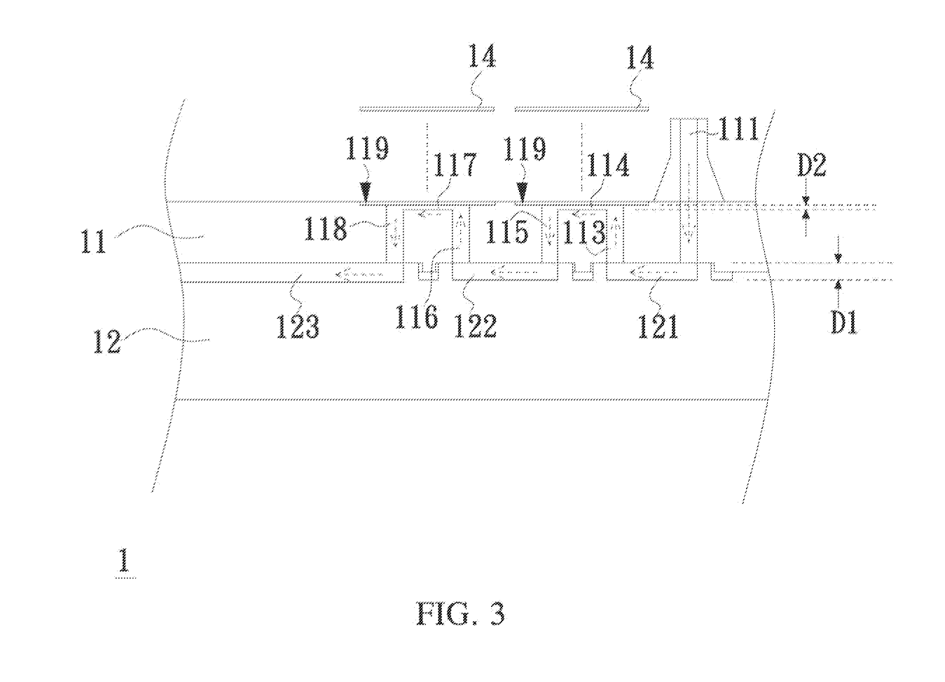

Please refer to FIGS. 1-3; FIG. 1 is an exploded-view diagram of the biological detecting chip of the present invention; FIGS. 2A-2C are schematic diagrams of the biological detecting chip after being assembled; FIG. 3 is schematic diagrams for the working fluid flowing inside the biological detecting chip. As shown in FIG. 1, the biological detecting chip 1 according to the present invention comprises an upper cap 11, a substrate 12, an optical fiber 13 and two gas filters 14. A detecting area 131 locates on the surface of the middle region of the optical fiber 13. The detecting area 131 is coated with gold nanoparticles by means of chemical bonds. Therefore, Surface Plasma Resonance (SPR) effect can be carried out to detect interactions between proteins or biological organisms and to measure biological characteristics thereof. An upside of the upper cap 11 has discharge channels 114 and 117, guiding channels 113, 115, 116 and 118, an inlet 111 and an outlet 112. The guiding channels 113, 115, 116 and 118 are vertically disposed and passed through the upper cap 11. A left end and a right end of the discharge channel 114 are respectively connected to an upper portion of the guiding channel 113 and the guiding channel 115. Similarly, a left end and a right end of the discharge channel 117 are respectively connected to an upper portion of the guiding channel 116 and the guiding channel 118. In this manner, as shown in FIG. 3, the guiding channel 113, the discharge channel 114 and the guiding channel 115 are connected in sequence and form a “┌┐” shape. Similarly, the guiding channel 116, the discharge channel 117 and the guiding channel 118 are connected in sequence and form a “┌┐” shape. Besides, the gas filters 14 may be optionally attached to an upside of the discharge channels 114 and 117. In this manner, the discharge channels 114 and 117 are separated and isolated from an outside of the upper cap 11.

Referring to FIG. 1 and FIG. 2A, an upside of the substrate 12 has a test area 124, a trough 128, a plurality of walls 129, a plurality of fitting elements 125 and a plurality of directing channels 121, 122 and 123. The directing channels 121, 122 and 123 are horizontally disposed. The walls 129 encircle and isolate the directing channels 121, 122 and 123. The trough 128, preferably concaved and disposed next to the walls 129, is disposed at an outside of the wall 129. In practice, the trough 128 may contain glue or other sticking materials.

When the upper cap 11 and the substrate 12 are aligned and combined, the fitting elements 125 may be fixed to the upper cap 11 or passed through the upper cap 11, so as to fasten the upper cap 11 and the substrate 12. In this manner, the fitting elements 125 may have guiding, positioning and fixing functions (as shown in FIG. 2B). Moreover, the optical fiber 13 is disposed and fixed between the upper cap 11 and the substrate 12 after the upper cap 11 is superimposed on the substrate 12, so as to arrange the detecting area 131 of the optical fiber 13 inside the test area 124. Besides, the test area 124 and the detecting area 131 of the optical fiber 13 define an optical axis Al, which crosses the direction of the directing channel 121, 122 or 123 by an angle θ. Preferably, the angle θ ranges from 1 to 90 degrees. In this manner, as shown in FIG. 2A and FIG. 3, the directing channel 121 is connected to the inlet 111 and the guiding channel 113; the directing channel 123 on the right hand side is connected to the guiding channel 118 and the test area 124; the directing channel 123 on the left hand side is connected to the test area 124 and the outlet 112; the directing channel 122 is connected to the distinct guiding channels 115 and 116 (i.e. the left end of the directing channel 122 is connected to the guiding channel 116, and the right end of the directing channel 122 is connected to the guiding channel 115).

Two gas filters 14 are attached to an upside of the discharge channels 114 and 117, so as to separate and isolate the working fluid inside the discharge channels 114 and 117 during the process of analyses of biological samples. Preferably, the gas filter 14 is a polymeric fabric with nano-size pores and a chemical inert characteristic, so that gas may be passed through the gas filter 14 and working fluid may be blocked and retained in of the discharge channels 114 and 117. In this manner, the gas filter 14 may have the function of air ventilation and of preventing the working fluid from leakage or flowing out. After the working fluid for biosample analyses is injected into the inlet 111 of the upper cap 11, the fluid may flow, in sequence, to the directing channel 121, the guiding channel 113, the discharge channel 114, the guiding channel 115, the directing channel 122, the guiding channel 116, the discharge channel 117, the guiding channel 118, and the directing channel 123 and then flow out of the outlet 112 and leave the biological detecting chip 1. In this manner, the working fluid inside the biological detecting chip 1 flows along a wiggly and undulated channel before being discharged.

Furthermore, after the upper cap 11 and the substrate 12 are combined and the working fluid is injected, the working fluid flows from the guiding channels 113 and 116 to the discharge channels 114 and 117; and then the gas (i.e. a plurality of bubbles) in the working fluid may be filtered and removed by means of the ventilation of the gas filter 14. Therefore bubbles are reduced and even diminished. The degassed working fluid then flows to the guiding channel 118 and the directing channel 123 and enters the test area 124. The degassed fluid will not be able to affect the sensitivity of the optical fiber 13 (or the detecting area 131) and thus the effectiveness of the experiment is improved. Theoretically, the bubbles in the working fluid may be moved upward by means of buoyancy and pressurization in the channel; therefore the bubbles may be forced to move upward and are filtered through the gas filter 14. After several experiments, in a preferred embodiment the directing channels 121, 122 and 123 may be 0.8 mm in height D1, and the discharge channels 114 and 117 may be 0.25 mm in height D2, so as to achieve an optimal ratio of flowing velocity to removal rate of the bubbles. Besides, the optical axis A1 and the directing channels 121, 122 and 123 have crossed by an angle θ. When the working fluid flows to the test area 124, the working fluid will not acutely burst or smash the test area 124; therefore bubble generation in the test area 124 is reduced and even diminished. Thus the entire biological detecting chip 1 may have minimal number of bubbles.

In a preferred embodiment, an upside of the upper cap 11 further has at least one receiving room 119 concaved on the upper cap 11. As shown in FIG. 1 and FIG. 3, the receiving room 119 is disposed next to the discharge channels 114 and 117. The gas filter 14 is optionally disposed and attached in the receiving room 119. In this manner, an upper surface of the biological detecting chip 1 is kept plane and smooth with the gas filter 14 assembled inside the biological detecting chip 1.

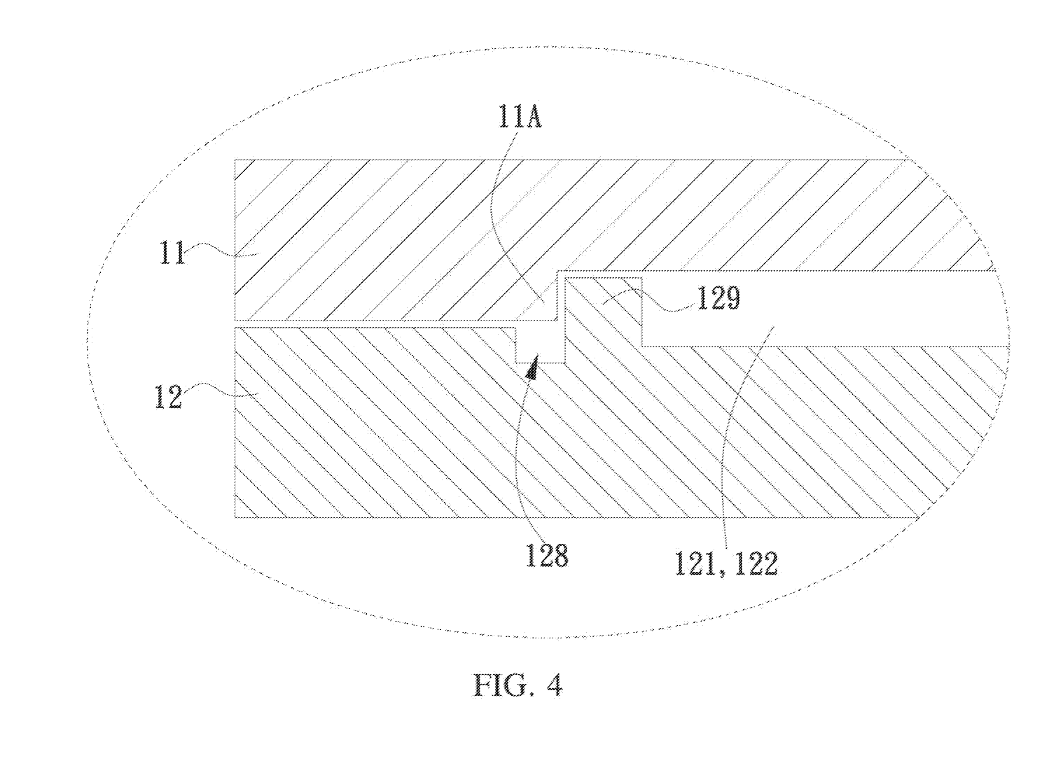

As shown in FIG. 4 and FIG. 1, the trough 128 disposed at an outside of the walls 129 is concaved and disposed next to the wall 129; in addition, the wall 129 protrudes and has a higher altitude than an upper surface of the substrate 12. When the upper cap 11 and the substrate 12 are combined, the seal portion 11A of the upper cap 11 may block or seal the glue (or other sticking materials) inside the trough 128. Therefore the glue may bond the upper cap 11 and the substrate 12 together. The wall 129 protruding from an interior of the biological detecting chip 1 may prevent the glue from entering the directing channels 121 and 122; therefore the glue will not block or jam the directing channels 121 and 122.

Therefore, the biological detecting chip 1 may reduce bubble generation in the working fluid, so as to improve the accuracy/sensitivity of biosample analyses, restrain optical variation for signal detection caused by the working fluid, and decrease noise of bio-chemical measurement.

Summarily, the biological detecting chip 1 of the present invention may effectively control the generation of bubbles inside the channels of the chip. Therefore, the plasma effect of the gold nanoparticles in the optical fiber is increased, and the biological detecting chip is improved in its sensing accuracy of experimental signal. Thus the commercialization of the present invention is predictable.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A biological detecting chip, comprising:
an optical fiber with at least one detecting area disposed on an outer surface;
at least one gas filter;
an upper cap, having at least two guiding channels passed through the upper cap, at least one discharge channel with two ends connecting to an upper portion of distinct guiding channels, an inlet and an outlet, wherein the gas filter is attached to an upside of the discharge channel, to separate the discharge channel and an outside of the upper cap; and
a substrate, having a test area and a plurality of directing channels, wherein the directing channel connects to the inlet and the guiding channel, connects to the guiding channel and the test area, and connects to the test area and the outlet;
wherein the optical fiber is fixed between the upper cap and the substrate, with the detecting area disposed inside the test area and having an optical axis which crosses the directing channel by an angle.

2. The biological detecting chip of claim 1. wherein an upper surface of the upper cap has at least one receiving room disposed next to the discharge channel and optionally containing the gas filter.

3. The biological detecting chip of claim 1, wherein the guiding channel is vertically disposed.

4. The biological detecting chip of claim 1, wherein the directing channel is horizontally disposed.

5. The biological detecting chip of claim 1, wherein the number of the gas filter and the discharge channel are pluralities, and each of the directing channels connects to distinct guiding channels.

6. The biological detecting chip of claim 1, wherein the angle ranges from 1 to 90 degrees.

7. The biological detecting chip of claim 1, wherein the substrate has at least one wall to isolate and encircle the directing channel.

8. The biological detecting chip of claim 7, wherein the wall either protrudes or has a higher altitude than an upper surface of the substrate.

9. The biological detecting chip of claim 7, wherein an outside of the wall has a trough concaved and disposed next to the wall.

10. The biological detecting chip of claim 1, wherein the substrate has a plurality of fitting elements fastened to the upper cap or passed through the upper cap.
